(19) United States
(12) Patent Application Publication
(10) Pub. No.: US 2005/0004336 A1
(43) Pub. Date: Jan. 6, 2005

(54) Method for synthesizing conducting polymers from neat monomer solutions

(76) Inventor: Patricia Ann Mabrouk, Boston, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/842,249

(22) Filed: May 10, 2004

Related U.S. Application Data
(60) Provisional application No. 60/469,624, filed on May 8, 2003.

(51) Int. Cl. C08F 26/06

(52) U.S. Cl. 526/258

(57) ABSTRACT

A method for electrochemically synthesizing polymers from neat monomer solutions is disclosed. Syntheses of such polymers are carried out in the presence of electrolyte-dopants, which influence the physical and chemical properties of the resulting polymer, particularly conductive polymers. These syntheses occur in an electrochemical cell having working and counter electrodes suitable for electrochemical oxidation and reduction. The method is particularly convenient for synthesizing conductive polypyrrole from a neat pyrrole monomer solution. Polypyrrole synthesized according to this method has a conductivity comparable to conductive polypyrrole synthesized via typical chemical and electrochemical methods.

### CROSS REFERENCE TO RELATED APPLICATIONS

This application claims the priority of U.S. Provisional Application No. 60/469,624 filed May 8, 2003 entitled, A NOVEL, GREEN METHOD FOR SYNTHESIZING CONDUCTING POLYPYRROLE, the whole of which is hereby incorporated by reference herein.

### STATEMENT REGARDING FEDERALLY SPONSORED RESEARCH OR DEVELOPMENT

Part of the work leading to this invention was carried out with United States Government support provided by the National Science Foundation under Grant No. DMR-0213282. Therefore, the U.S. Government has certain rights in this invention.

### BACKGROUND OF THE INVENTION

In both academic and industrial settings, there is a growing interest in the study and use of polymers, particularly conductive polymers. Conductive polymers are polymers that generally have the electrical and optical properties of inorganic metals and semiconductors. These conductive polymers are associated with a charged ion, which alters the polymer's physical and chemical properties. Such charged ions are known as polymeric “dopants.”

Polypyrrole is a widely used conductive polymer. The widespread use of polypyrrole relates in part to the convenience of synthesizing the polymer. The versatility of polypyrrole is another reason for the polymer's popularity. For example, conductive polypyrrole is used in the field of molecular electronics. Other commercial applications include anticorrosion coatings, antistatic coatings, electrochromic devices, fuel cell membranes, electromagnetic shielding, sensors, analytical separations, piezoceramics, electrostatic materials, electromechanical actuators, conducting adhesives, printed circuit boards, dielectric coatings and artificial nerves.

Generally, polypyrrole is synthesized in two forms, thin films and colloidal dispersions. The electrical and optical properties of conductive polypyrrole are affected by the form of the polymerized polymer. These properties are also influenced by the dopant associated with the polymer.

Conductive polypyrrole may be synthesized via chemical and electrochemical methods. The chemical structure of a polypyrrole species synthesized by oxidation is represented as: 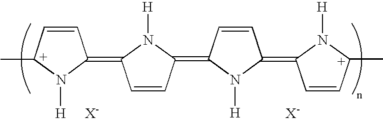
Anion dopants (X⁻) are associated with this polycationic species to yield overall charge neutrality.

Conventional chemical and electrochemical methods for synthesizing polypyrrole involve dilute aqueous or nonaqueous pyrrole monomer solutions. These solutions may also include organic solvents or acids. The excess of such solvents and acids remaining after polymerization presents difficult hazardous waste disposal problems. Additionally, solvent and acid excesses tend to increase synthesis costs. Thus, it is environmentally and economically desirable to avoid using organic solvents and acids in polymer syntheses, if possible.

### SUMMARY OF THE INVENTION

The present invention is directed to the synthesis of polymers, particularly conductive polymers. In one embodiment, conductive polypyrrole is synthesized from a neat pyrrole monomer solution. This synthesis method involves the electrochemical polymerization of a pyrrole monomer from a neat solution of the monomer and an electrolyte of which the dopant is a part. The dopant associates with the conductive polypyrrole during a redox process. The type of dopant associated with the polymer influences the physical and chemical properties of the polymer. For example, a conductive polypyrrole doped with nitrate may have a different conductivity from one doped with chloride.

Preferably, the electrochemical synthesis of a conducting polymer occurs in an electrochemical cell. The electrochemical cell includes a working and a counter electrode. These electrodes accomplish the electrochemical oxidation or reduction of conductive polymers. The electrochemical oxidation of polypyrrole, for example, may occur on an indium tin oxide (ITO) coated glass slide or a gold flag electrode.

The present invention is also directed to a conductive polypyrrole electrochemically synthesized from a neat pyrrole monomer solution. The morphology of the polymer may vary depending on synthesis conditions, such as, for example, temperature, the type of working electrode, the electrical excitation used, the type of electrolyte-dopant and the relevant electrochemical parameters including, but not limited to, potential and scan rate.

The conductive polymers of the present invention are most easily formed as thin films, although other polymeric forms are capable of being synthesized. For example, fairly uniform films that are about 3 microns in thickness may be prepared within hours by the method of the present invention. Thin film conductive polymers are useful in a variety of applications. Polypyrrole films, for example, are used in such fields as molecular electronics, anticorrosion coatings, antistatic coatings, electrochromic devices, fuel cell membranes, electromagnetic shielding, sensors, analytical separations, piezoceramics, electrostatic materials, electromechanical actuators, conducting adhesives, printed circuit boards, dielectric coatings and artificial nerves.

### DESCRIPTION OF THE DRAWINGS

Not applicable.

### DETAILED DESCRIPTION OF THE INVENTION

Conductive polymers are polymers that have the physical and chemical properties of a polymer and the electrical and optical properties of inorganic metals and semiconductors. These polymers may also be doped in order to alter their polymeric properties. A variety of methods are known for synthesizing conductive polymers. These methods include cationic, anionic and radical chain growth, coordination polymerization, step growth polymerization and electrochemical polymerization.

Electrochemical polymerization of conductive polymers typically occurs by way of a redox process. Redox processes are well-suited for synthesizing π-conjugated conductive polymers. A common redox process is electrochemical oxidation, which occurs as a monomer is oxidized into a radical cation. This species is extremely reactive, and multiple radical cations readily combine to form dimers, trimers, oligomers and, finally, polymers.

Conductive polypyrrole is a commonly synthesized polymer because of its good electrical and optical properties. Polypyrrole is also a physically and chemically stable conductive polymer. Polypyrrole is synthesized from pyrrole monomers in the presence of an electrolyte-dopant.

The chemical structure of oxidized conducting polypyrrole is shown as: 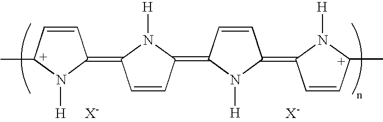
This highly conjugated polypyrrole species permits electron transfer between different lattice structures. The oxidized conducting polypyrrole also associates with anion dopants (X⁻). These anion dopants yield overall charge neutrality for the polycationic polymer. It is understood that the syntheses of other polymers according the method of the invention are carried out through mechanisms similar to that described for polypyrrole.

The present invention is directed to a method of synthesizing conductive polymers. In one embodiment, conductive polypyrrole is electrochemically synthesized from a solution of neat pyrrole monomer and an electrolyte-dopant. Different embodiments may contemplate the synthesis of other polymers, such as, for example, polythiophene, polyphenol, polyaniline, polyacetylene and polyphenylene, from appropriate neat monomer solutions. These electrochemical syntheses will be understood by one of ordinary skill in the art to be carried out by redox processes.

In general, redox processes may be performed galvanically or voltammetrically. Galvanostatic conditions impose an electric current to carry out the redox process. Similarly, voltammetric conditions impose a potential. Electric current or potential may also be stepped or ramped in a galvanostatic or potentiostatic process, respectively. The synthesis method of the present invention is preferably carried out via cyclic voltammetry, although different conditions for polymerization could be contemplated by those of ordinary skill in the art. In one embodiment, a potential is varied from −1.0 to 1.0 volts versus a silver-silver chloride reference electrode during the synthesis of a conductive polypyrrole. Moreover, this synthesis is performed at a scan rate of 100 millivolts per second (mV/s). It is appreciated that these synthesis conditions may be substantially altered for optimization of the method of the invention. The potential, for example, may be varied across a wider range, a different scan rate may be used or the polymerization temperature may be changed. It is also understood that excessive potentials may cause a polymer to become physically and chemically unstable.

Redox processes are ordinarily carried out in an electrochemical cell. In one embodiment, an electrochemical cell contains a solution of neat monomer and an electrolyte-dopant. Numerous electrolyte-dopants are recognized for use in the electrochemical synthesis of conductive polymers. These electrolyte-dopants, however, vary depending on whether an electrochemical synthesis is oxidative or reductive. Several examples of anion electrolyte-dopants associated with electrochemical oxidation include arsenic pentachloride, iron III chloride, nitrosonium hexafluorophosphate (NOPF₆), tetra-n-butylammonium perchlorate (TBAClO₄), tetrabutylammonium hexafluoroborate (TBABF₄), tetrabutylammonium hexafluorophosphate (TBAPF₆), potassium nitrate and sodium dodecylbenzenesulfonate. A typical cation electrolyte-dopant for reduction is sodium naphthalide. In biological applications, dopants may also include, for example, collagen, heparin, adenosine and various enzymes.

Different electrolyte-dopants are understood to alter the physical and chemical properties of a polymer. For example, the intrinsic color and conductivity of a polymer may be influenced by a particular dopant or a combination of dopants. Similarly, a dopant may affect a polymer's stability and morphology.

A conventional electrochemical cell in which a redox process is carried out includes working, counter and reference electrodes. These electrodes are immersed in the solution of monomer and electrolyte-dopant, which is contained in the cell. In one embodiment, the working electrode is an indium tin oxide (ITO) coated glass slide and the counter electrode is platinum mesh. One of ordinary skill in the art recognizes that these electrodes may be any kind suitable for electrochemical oxidation or reduction reactions. For example, the working electrode of an electrochemical cell may be aluminum, platinum, gold, stainless steel or iron. It is also contemplated that the working electrode may be any semiconductor or metal desired to be coated with a conductive polymeric film such as, for example, sulfide, cadmium selenide or silicon.

During synthesis, a conductive polymer is precipitated or polymerized onto a working electrode. In one embodiment, polypyrrole precipitates onto the working electrode as a thin film. The polymers prepared by this method may be suitably processed to yield other useful forms of conductive polymers according to the present invention. These forms may, for example, include colloidal dispersions.

It is known that thin conductive polymeric films commonly have distinctive morphologies. Such morphologies may affect the electrical and optical properties of the polymer. Reflectance is one such optical property influenced by a polymer's morphology. The morphology of a polymeric film may also vary depending on different synthesis conditions, such as, for example, a change in the type of working electrode. Another condition affecting morphology may be the kind of electrolyte-dopant used during polymerization. The concentration of an electrolyte-dopant is also presumed to have an effect on polymeric morphology.

Additionally, conditions for polymerization may affect the thickness of a polymeric film. These conditions include, for example, the type of working electrode used for polymerization. Different electrolyte-dopants and their concentrations are also conjectured to influence polymeric film thickness. For example, higher dopant concentrations are expected to produce thicker and more conductive films.

One of ordinary skill in the art will appreciate that an electrochemically synthesized conductive polymer may be recovered from the working electrode on which it is precipitated. This recovery yields a conducting polymer suitable for use in applications other than those related to thin films. Such recoveries are possible through any appropriate chemical or mechanical means including, but not limited to, dissolving the polymer film in a suitable solvent, or peeling the film from an electrode substrate and sonicating or grinding it to produce fine particles.

The synthesis method of the present invention is presumed to proceed more rapidly than comparable electrochemical and chemical polymerizations. This is conjectured to occur due to higher electrolyte-dopant concentrations, which may cause unique charge transportation conditions within the neat monomer solution, or redox liquid.

A significant advantage of the present invention is that it is directed to a synthesis method that can be carried out without additional organic solvents, acids or aqueous solutions. The present invention avoids such hazardous wastes and the problems associated with their disposal. Thus, various environmental and economical advantages of the present invention are recognized by those of ordinary skill in the art.

When the method of the present invention is scaled-up to an industrial process, additional unit operations are not required. Commonly, an industrial polymerization process requires such unit operations to deal with organic solvent and acid excesses. The present invention avoids these industrial problems by using a “neat” monomer solution. Neat monomer solutions are not diluted, in comparison to the aqueous or nonaqueous monomer solutions of conventional electrochemical and chemical syntheses. Accordingly, the present invention does not require large industrial unit operations to produce an adequate polymer yield.

The synthesis method of the present invention is also expected to be less expensive than standard synthesis processes, as solvent and chemical oxidants are not required. For this reason, the present invention, again, involves less waste materials.

The difficulties associated with standard synthesis methods have limited the development of conductive polymers. The advantages of the present invention make conductive polymers more convenient and suitable for academic and industrial applications. The present invention also yields more versatile polymers, as their properties may be easily changed under different synthesis conditions, such as, for example, use of a specific electrolyte-dopant. The present invention advances the use of conductive polymers in such fields as molecular electronics, anticorrosion coatings, antistatic coatings, electrochromic devices, fuel cell membranes, electromagnetic shielding, sensors, analytical separations, piezoceramics, electrostatic materials, electromechanical actuators, conducting adhesives, printed circuit boards, dielectric coatings and artificial nerves.

### EXAMPLE I

A method for electrochemically synthesizing conductive polypyrrole was accomplished by polymerizing a neat pyrrole monomer solution (Aldrich). The neat monomer solution was distilled under nitrogen prior to use. A tetra-n-butylammonium hexafluorophosphate (TBAPF₆) electrolyte-dopant was used as received.

Additionally, the materials for this synthesis included an indium tin oxide (ITO) coated glass working electrode (Delta Technologies). The ITO coated glass electrode was prepared using a 1 centimeter by 1 centimeter block. A platinum mesh counter electrode (Aldrich), and a standard silver-silver chloride reference electrode (Bioanalytical Systems) were also used. The reference electrode was saturated with a 3 molar solution of sodium chloride (NaCl). The synthesis method was performed using a BAS-100B electrochemical workstation.

The synthesis was carried out in a conventional one-compartment electrochemical cell. The cell contained a solution of 10 milliliters of the neat monomer and 1.0 millimole of the electrolyte-dopant. The working, counter and reference electrodes were immersed in the solution including the monomer and the electrolyte-dopant. The potential was cycled between −1.0 to 1.0 volts versus the silver-silver chloride reference electrode at a scan rate of 100 millivolts per second (mV/s) for a period of 45 minutes. Each cycle polymerized more of the pyrrole monomer onto the working electrode. Polymerization is evidenced by the increase in current with each successive voltammogram cycle.

### EXAMPLE II

A conductive polypyrrole was synthesized according to the method of the present invention. The resultant polymer was a black, thin film electrochemically oxidized onto a working electrode. The thickness of the conductive film was investigated via profilometry methods and shown to be 3 microns thick. The conductivity of this 3 micron thick film was measured using the van Der Pauw method (http://www.eeel.nist.gov/812/effe.htm#vand). A conductivity of 0.45 siemens per centimeter (S/cm) was determined, a result which is comparable to the conductivity of polypyrrole synthesized in either acetonitrile or an aqueous acid solution.

While the present invention has been described in conjunction with a preferred embodiment, one of ordinary skill in the art, after reading the foregoing specification, will be able to effect various changes, substitutions of equivalents, and other alterations to the compositions and articles set forth herein. It is therefore intended that the protection granted by Letter Patent hereon be limited only by the definitions contained in the appended claims and equivalents thereof.

1. A method of electrochemically synthesizing a conductive polypyrrole from a neat pyrrole monomer solution, the method comprising:
subjecting a solution of a neat pyrrole monomer and a dopant to a redox process suitable for polymerization; and
precipitating the resulting conductive polypyrrole.

2. A conductive polypyrrole made in accordance with the method of claim 1.

3. The method of claim 1, wherein the redox process is accomplished by cyclic voltammetry.

4. The method of claim 1, wherein the redox process is carried out in an electrochemical cell comprising:
said solution of a neat pyrrole monomer and a dopant; and
an electrode system immersed in said solution.

5. The method of claim 4, wherein the electrode system comprises:
a working electrode; and
a counter electrode.

6. The method of claim 1, wherein the redox process comprises the steps of:
applying a controlled potential to an electrode immersed in said solution; and
polymerizing said pyrrole monomers.

7. The method of claim 6, wherein the controlled potential is in a range from about −1.5 volts to about 1.5 volts.

8. The method of claim 1, wherein the precipitation of the conductive polypyrrole occurs on a working electrode.

9. The method of claim 8, further comprising the step of:
recovering the conductive polypyrrole from the working electrode.

10. The method of claim 1, wherein the redox process is accomplished by galvanic cycles.

11. The method of claim 1, wherein the redox process comprises the steps of:
applying a controlled current to an electrode immersed in said solution; and
polymerizing said pyrrole monomers.

12. The method of claim 1, wherein the dopant is selected from an electrolyte-dopant of the group consisting of tetra-n-butylammonium perchlorate, tetrabutylammonium hexafluoroborate, potassium nitrate and tetrabutylammonium hexafluorophosphate.

13. The method of claim 5, wherein the working electrode is an indium tin oxide coated glass slide.

14. The method of claim 5, wherein the counter electrode is a platinum mesh.

15. A method of electrochemically synthesizing a conductive polymer from a neat monomer solution, the method comprising:
subjecting a solution of a neat monomer and a dopant to a redox process suitable for polymerization; and
precipitating the resulting conductive polymer.

16. A conductive polymer made in accordance with the method of claim 15.

17. The method of claim 15, wherein the redox process is accomplished by cyclic voltammetry.

18. The method of claim 15, wherein the redox process is carried out in an electrochemical cell comprising:
said solution of a neat monomer and a dopant; and
an electrode system immersed in said solution.

19. The method of claim 18, wherein the electrode system comprises:
a working electrode; and
a counter electrode.

20. The method of claim 15, wherein the redox process comprises the steps of:
applying a controlled potential to an electrode immersed in said solution; and
polymerizing said monomers.

21. The method of claim 20, wherein the controlled potential is in a range from about −1.5 volts to about 1.5 volts.

22. The method of claim 15, wherein the precipitation of the conductive polymer occurs on a working electrode.

23. The method of claim 22, further comprising the step of:
recovering the conductive polymer from the working electrode.

24. The method of claim 15, wherein the redox process is accomplished by galvanic cycles.

25. The method of claim 15, wherein the redox process comprises the steps of:
applying a controlled current to an electrode immersed in said solution; and
polymerizing said monomers.

26. The method of claim 15, wherein the dopant is selected from an electrolyte-dopant of the group consisting of tetra-n-butylammonium perchlorate, tetrabutylammonium hexafluoroborate, potassium nitrate and tetrabutylammonium hexafluorophosphate.

27. The method of claim 19, wherein the working electrode is an indium tin oxide coated glass slide.

28. The method of claim 19, wherein the counter electrode is a platinum mesh.
